(19) United States
(12) Patent Application Publication
(10) Pub. No.: US 2009/0004430 A1
(43) Pub. Date: Jan. 1, 2009

(54) Reinforced elastomeric configuration tailored to meet a user's requirements for protecting a structure and a structure comprised thereof

(76) Inventors: Toney K. Cummins, Vicksburg, MS (US); Richard E. Magee, Vicksburg, MS (US); Pamela G. Kinnebrew, Vicksburg, MS (US); Bartley P. Durst, Clinton, MS (US); James L. Davis, Vicksburg, MS (US); Carol F. Johnson, Vickburg, MS (US)

Correspondence Address: HUMPHREYS ENGINEER CENTER SUPPORT ACTIVITY;ATTN: CEHEC-OC, 7701 TELEGRAPH ROAD, ALEXANDRIA, VA, 22315-3860, US

(21) Appl. No.: 11/819,340

(22) Filed: Jun. 27, 2007

(51) Int. Cl. B32B 5/12; B32B 3/12

(52) U.S. Cl. 428/113; 428/135

(57) ABSTRACT

A prophylactic system that reduces or eliminates damage to resources on the side of a structure opposite the side on which a dynamic force is imposed. The system comprises an elastic membrane or sheet, with reinforcement of a toughness tailored to a user's requirements incorporated in the membrane and an adhesive for installation. In one embodiment, the reinforcement is comprised of bundles of fibers aligned in a scrim comprising warp fiber bundles and weft fiber bundles arranged so that fiber bundles are non-parallel to each axes defining the length and the width of the membrane. The fiber bundles are aligned to create spacing between each fiber bundle and an adjacent parallel fiber bundle. An adhesive is used to affix the reinforced membrane to the side of the structure away from the expected force. No protective gear specific to application or use of the adhesive is required to install the system.

### STATEMENT OF GOVERNMENT INTEREST

Under paragraph 1(a) of Executive Order 10096, the conditions under which this invention was made entitle the Government of the United States, as represented by the Secretary of the Army, to an undivided interest therein on any patent granted thereon by the United States. This and related patents are available for licensing to qualified licensees. Please contact Phillip Stewart at 601 634-4113.

### BACKGROUND

A need exists for inexpensive protective cladding with superior resistance to wind damage, including penetration of debris generated by natural forces, such as tornadoes and hurricanes. Coating or covering the inexpensive core of a structure, such as a wall, with a pliable material of a tailored “toughness” reduces or completely eliminates the generation of structural debris and through penetration of fragments and debris from an event such as a hurricane, tornado, or even a nearby explosion such as may occur with a natural gas line rupture.

Select embodiments of the present invention also have excellent energy absorbing capacity against blast forces. This capacity is often described as toughness. Select embodiments of the present invention obtain their toughness qualities through engineering of the type and quantity of component materials as well as engineering the geometry of components as applied in specific applications.

Further, because select embodiments of the present invention provide a tailored toughness, they are suitable for employment with structural members, such as sheetrock-based walls, that may be used in residential housing as well as employment in commercial structures such as banks or security vaults. Structural members thus modified protect against natural forces, specifically dynamic loading and debris impact from nearby blasts, tornados and hurricanes.

### BRIEF DESCRIPTION OF DRAWINGS

FIG. 1 is a perspective view detailing the geometry of a component of an embodiment of the present invention.

FIG. 2 is a perspective view of an embodiment of the present invention.

FIG. 3 is a perspective view detailing an alternate geometry of a component of an embodiment of the present invention.

FIG. 4 is a graph of applied pressure versus deflection from hydrostatic testing of three reinforced elastomeric configurations that may be affixed to a structure to provide benefit.

FIG. 5 is a pictorial representation of the result of blast testing of an un-reinforced elastomeric configuration applied to a sub-scale CMU test wall.

FIG. 6 is a pictorial representation of the result of blast testing of a 0/90° reinforced elastomeric configuration applied to a sub-scale CMU test wall.

FIG. 7 is a pictorial representation of the result of blast testing of a first reinforced elastomeric configuration of the present invention applied to a sub-scale CMU test wall.

FIG. 8 is a pictorial representation of the result of blast testing of a second reinforced elastomeric configuration of the present invention applied to a sub-scale CMU test wall.

FIG. 9 is a pictorial representation of the result of blast testing of a third reinforced elastomeric configuration of the present invention applied to a full-scale CMU test wall.

FIG. 10 is a pictorial representation of the result of blast testing of a fourth reinforced elastomeric configuration of the present invention applied to a sub-scale CMU test wall.

FIG. 11 is a pictorial representation of the result of blast testing of a fifth reinforced elastomeric configuration of the present invention applied to a full-scale CMU test wall.

### DETAILED SPECIFICATION

In select embodiments of the present invention, a prophylactic system, tailored to meet a user's requirements, reduces or eliminates damage to the inside of a structure having exterior sides which upon impact by an external force would otherwise generate flying debris inside the structure. The prophylactic system comprises an elastic membrane (elastomeric configuration) having a length, a width, and a thickness, the thickness much less than either of the length or width; reinforcement incorporated in the membrane comprised of bundles of fibers aligned in a scrim comprising warp fiber bundles and weft fiber bundles arranged so that fiber bundles are non-parallel to each of the longitudinal axis defining the length and the horizontal axis defining the width of the membrane and the fiber bundles are aligned to create spacing between each fiber bundle and an adjacent parallel fiber bundle; and an adhesive applied to affix the reinforced membrane to the inside of the exterior sides.

In select embodiments of the present invention, the membrane is a polymer or copolymer in which the reinforcement is embedded at the place of manufacturing of the membrane. In select embodiments of the present invention, the membrane is provided in a thickness between about 10 mil to about 0.5 in. (12.7 mm), preferably in a thickness between about 50 and about 100 mil.

In select embodiments of the present invention the membrane is capable of elongation from about 100% to about 500%.

In select embodiments of the present invention one or more types of the fibers comprise one or more types of polymer or copolymer, the fibers incorporated in the fiber bundles to comprise the warp and weft of the scrim, the fiber bundles having a length, a width much less than the length and a thickness much less than the width, and the fiber bundles aligned so that the spacing is defined by a pre-specified clear space ratio (CSR) defined as the area of the scrim covered by the fiber bundles divided by the area of the scrim that is not covered by the fiber bundles.

In select embodiments of the present invention, CSR is specified to be between about 0.25 and about 4.0.

In select embodiments of the present invention the types of fibers are selected from: polyester, aramid, para-aramid, aromatic polyamide, poly(p-phenylene-2,6-benzobiosoxazole), fiberglass, carbon fiber, polypropylene, nylon, aliphatic polymer, ultra-high molecular weight polyethylene (UHMWPE), high modulus polyethylene (HMPE), geo-grid material, bi-axial geo-grid material, geo-fabric material, bi-axial geo-fabric material, metallic grids, metallic meshes, metallic membranes, and combinations thereof.

In select embodiments of the present invention the configuration of the fiber bundles may be: woven, braided, stitched, mesh fabric, and combinations thereof.

In select embodiments of the present invention, the warp fiber bundles of the reinforcing scrim are fixed at between about 30 and about 60 degrees with respect to the longitudinal axis of the membrane and the weft fiber bundles of the reinforcing scrim are fixed about perpendicular to the warp fiber bundles.

In select embodiments of the present invention the warp fiber bundles of the reinforcing scrim are fixed at between about 30 and about 60 degrees with respect to the longitudinal axis of the membrane and the weft fiber bundles of the reinforcing scrim are fixed non-perpendicular to the warp fiber bundles.

In select embodiments of the present invention the warp fiber bundles of the reinforcing scrim are fixed at about 45 degrees with respect to the longitudinal axis of the membrane and the weft fiber bundles of the reinforcing scrim are fixed about perpendicular to the warp fiber bundles.

In select embodiments of the present invention the warp fiber bundles of the reinforcing scrim are fixed at about 45 degrees with respect to the longitudinal axis of the membrane and the weft fiber bundles of the reinforcing scrim are fixed non-perpendicular to the warp fiber bundles.

In select embodiments of the present invention the reinforced membrane is extended to be affixed to one or more portions of the structure that abut one or more sides of the structure.

In select embodiments of the present invention the reinforced membrane is extended to be affixed to both the ceiling and the floor abutting exterior walls of a structure.

In select embodiments of the present invention the adhesive is applied to sides of the structure, such as exterior walls, prior to affixing the reinforced membrane to the sides.

In select embodiments of the present invention adhesive is applied to both the membrane and the sides of the structure prior to affixing the reinforced membrane to the sides.

In select embodiments of the present invention the adhesive is applied to the reinforced membrane prior to affixing the reinforced membrane to the sides of the structure.

In select embodiments of the present invention the adhesive is applied to the reinforced membrane at the place of manufacture of the reinforced membrane and the applied adhesive protected with a peelable sheet that is removed just prior to installing the reinforced membrane.

In select embodiments of the present invention the adhesive is of a type that may be used with no need for safety gear specific to use of the adhesive.

In select embodiments of the present invention the components of the adhesive may comprise: rubber, acrylic, epoxy, urethane, polyurea and combinations thereof.

In select embodiments of the present invention the adhesive has a minimum bond strength of at least 40 oz./in. to maintain a cohesive bond to the structural element.

In select embodiments of the present invention the adhesive is applied at a thickness from about 2 mil to about 50 mil.

In select embodiments of the present invention a structure having at least exterior walls incorporates a prophylactic system, tailored to meet a user's requirements, for significantly reducing or eliminating hazards to occupants and damage to the inside of the structure in which the exterior walls are impacted by an external force that otherwise would generate flying debris inside the structure. The prophylactic system comprises: an elastic membrane (elastomeric configuration) having a length, a width, and a thickness, the thickness much less than either of the length or width; reinforcement incorporated in the membrane comprised of bundles of fibers aligned in a scrim comprising warp fiber bundles and weft fiber bundles arranged so that the fiber bundles are non-parallel to each of the longitudinal axis defining the length and the horizontal axis defining the width of the membrane and the fiber bundles are aligned to create spacing between each fiber bundle and an adjacent parallel fiber bundle; and an adhesive applied to affix the reinforced membrane to the inside of the exterior walls.

In select embodiments of the present invention a prophylactic system, tailored to meet a user's requirements, significantly reduces or eliminates hazards and damage to items outside a structure, the interior of the sides (such as exterior walls) of which are impacted by an internal force that otherwise would generate flying debris outside the structure. The prophylactic system comprises: a membrane (an elastomeric configuration) having a length, a width, and a thickness, the thickness much less than either of the length or the width, the membrane incorporating reinforcement comprising bundles of fibers aligned in a scrim, the fiber bundles non-parallel to each of the axes defining the length and width of the membrane and the fiber bundles aligned to create spacing between each fiber bundle and a parallel fiber bundle; and an adhesive applied to affix the reinforced membrane to the outside of the sides of the structure.

In select embodiments of the present invention, a prophylactic system for reducing or eliminating damage to the inside of a structure having sides which upon impact by an external force would otherwise generate flying debris inside the structure, comprises: an elastomeric configuration of a toughness tailored to a user's requirements having a length, a width, and a thickness, the thickness much less than either of the length or width, the elastomeric configuration incorporating reinforcement comprising bundles of fibers aligned in a scrim comprising warp fiber bundles and weft fiber bundles, the fiber bundles approximately parallel to each of the axes defining the length and width of the elastomeric configuration, such that the fiber bundles are aligned to create spacing between each fiber bundle and a next fiber bundle parallel thereto, and wherein the prophylactic system is aligned on a bias with respect to either of the axes defining the length and width and adhesive applied to affix the reinforced elastomeric configuration to the inside of a side of the structure.

A prophylactic system for significantly reducing or eliminating damage to items outside a structure should the interior sides of exterior walls be impacted by an internal force that otherwise would generate flying debris outside the structure, comprising: an elastomeric configuration of a toughness tailored to a user's requirements having a length, a width, and a thickness, the thickness much less than either of the length or the width, the elastomeric configuration incorporating reinforcement comprising bundles of fibers, aligned in a scrim parallel to the axes defining the length and width of the reinforced elastomeric configuration such that the fiber bundles are aligned to create spacing between each fiber bundle and an adjacent parallel bundle, and such that the prophylactic system is aligned on a bias with respect to either of the axes defining the length and width of the reinforced elastomeric configuration; and adhesive applied to affix the reinforced elastomeric configuration to the outside of the exterior walls of the structure.

In select embodiments of the present invention the principal component of the elastomeric configuration is a membrane 101 or substrate comprising at least one material provided in at least one layer. Polymer or copolymer materials comprising a membrane 101 of select embodiments of the present invention may be selected from any of the following: elastomeric polymers, polyurethane, polyurea, polyethylene, polypropylene, polyolefin, silicone, polychloroprene (e.g., Neoprene), polyisoprene (e.g., natural rubber), isobutylene isoprene (e.g., butyl), polyvinylalcohol (PVA), polyvinylbutryl (PBA), polymer ionomer resins (e.g., SURLYN®), modified polyolefin, halogenated polyolefin, polyester, urethane, rubber (e.g., EPDM, Nitrile), hydrocarbons (e.g., ethylene-propylene terpolymer), chlorosulfonated polyethylene, styrene butadiene, polysulfide, acrylonitrile butadiene, fluoroelastomer, epichloronydrin, combinations thereof, and like materials with similar characteristics.

In select embodiments of the present invention a reinforced membrane 100 exhibits a strength of between about 100 to about 800 pounds per linear inch (pli). In select embodiments of the present invention the membrane itself 101 is provided in a thickness between about 10 mil to about 0.5 in. (12.7 mm), preferably between about 50 and about 100 mil. In select embodiments of the present invention the membrane 101 is capable of elongation from about 100% to about 500%.

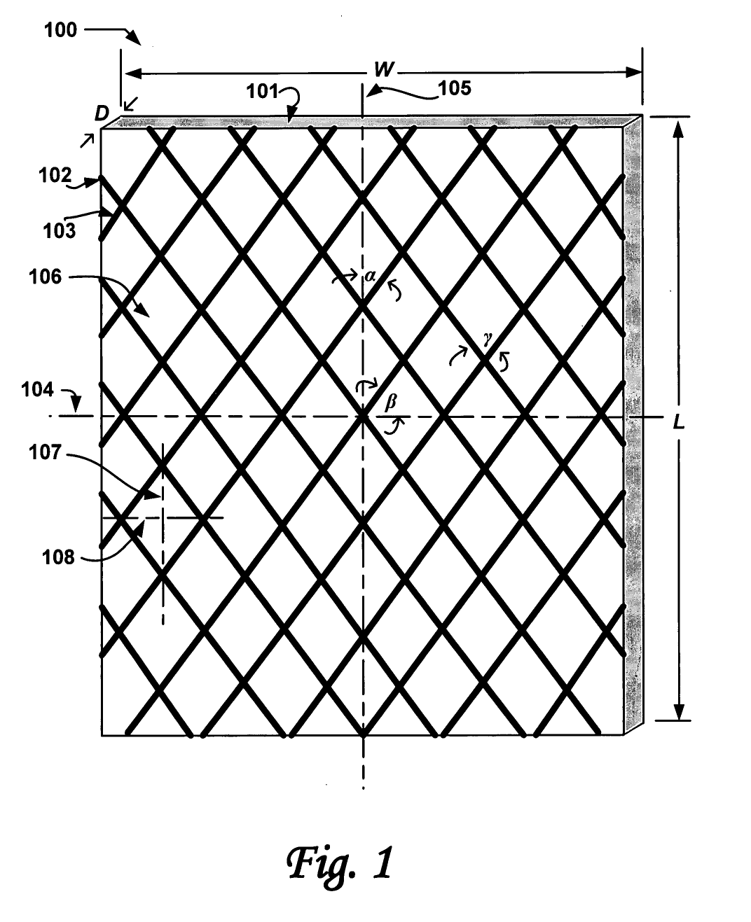

In select embodiments of the present invention reinforcement is provided as a scrim of elastic fiber “bundles” (hereafter simply termed fibers) 102, 103. Each bundle 102, 103 comprises one or more “ends” or “yarns” (of fibers) as necessary to meet a pre-specified strength. The fibers 102, 103 are of a pre-specified tensile strength and are woven in a loose weave to form a scrim. The warp fibers 103 interleave with the weft fibers 102 to produce a scrim resulting in a matrix of spaces 106 between the weft 102 and warp 103 fibers as shown in FIG. 1. Alternative embodiments of the present invention provide reinforcement as woven, braided, stitched, or mesh fabric configurations (not shown separately) that may not be as loosely configured as that shown in FIGS. 1, 2 and 3.

In select embodiments of the present invention, the fibers 102, 103 have a tensile strength of about 100 to 800 pli with a fiber denier of at least 10, an individual fiber breaking strength of at least 5 grams per denier, and the greatest dimension perpendicular to the longitudinal axis of the fiber (bundles) 102, 103 is at least 0.005 in. (0.13 mm). This “greatest dimension” could be a diameter for a cylindrical “bundle” or a width for a flat bundle having a length, width and depth (thickness).

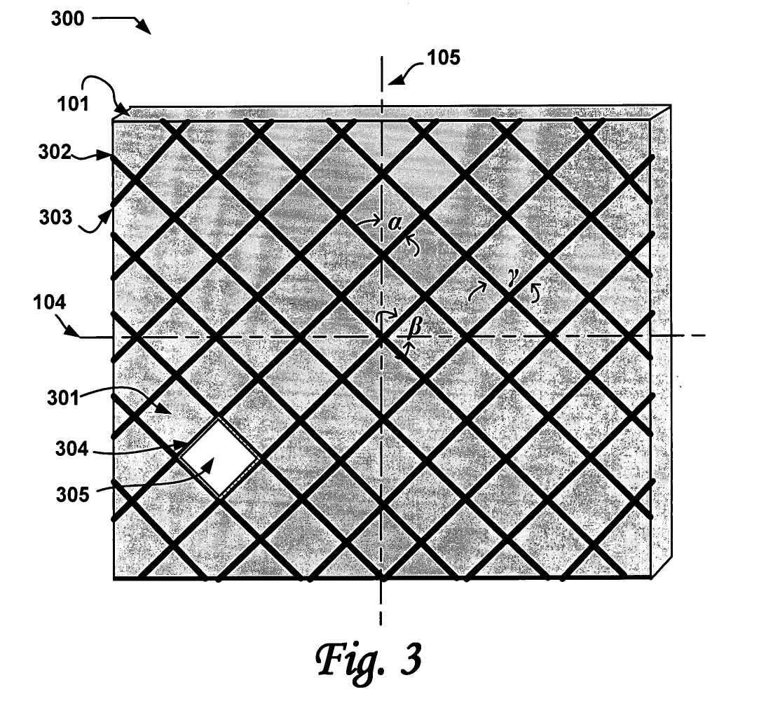

In select embodiments of the present invention, the fibers 102, 103 may be selected from any of the following: polyester, aramid (e.g., KEVLAR®), para-aramid, poly(p-phenylene-2,6-benzobiosoxazole)(ZYLON®), fiberglass, carbon fiber, polypropylene, nylon, aliphatic polymer (e.g., SPECTRA®, DYNEEMA®), ultra-high molecular weight polyethylene (UHMWPE) (or high modulus polyethylene (HMPE), geo-grid material, bi-axial geo-grid material, geo-fabric material, bi-axial geo-fabric material, metallic grids, metallic meshes, metallic membranes, and combinations thereof Refer to FIGS. 1 and 3. In select embodiments of the present invention the reinforcement is provided as a scrim of elastic fibers 102, 103 having a pre-specified tensile strength, woven in an open weave and incorporated in the depth, D, of the membrane 101 such that the warp fibers 102 are placed at an angle, a, with respect to the length, L, i.e., to the longitudinal axis 105 of the membrane 101, and the weft fibers 103 are placed at an angle, β (the complement of α), with respect to the width, W, i.e., the horizontal axis 104 of the membrane 101. In select embodiments of the present invention, the weave is loose so as to create significant spacing 106 between crossing warp 102 and weft 103 fibers. As shown in FIG. 1, α and β are not equal and γ is less than 90°, thus the spacing 106 is a “diamond” with a long axis 107 parallel to the longitudinal axis 105 of the membrane 101 and a short axis 108 parallel to the horizontal axis 104 of the membrane 101. Compare this to FIG. 3, where the warp 302 and weft 303 fibers are woven so as to create the spacing 301 as a square since a and β are equal (each 45°) and γ is 90°. Of course, if α is greater than 45° (not shown separately), then the long axis 107 of the diamond-shaped spacing 106 will be parallel to the horizontal axis 104 of the membrane 101.

In select embodiments of the present invention the type and geometry of the scrim to be used as reinforcement is specified. For example, refer to FIG. 3, showing a “clear” area 305 representing the area not covered by a fiber 302, 303 in one of the “squares” 301 of the scrim. The cross-hatched area 304 represents half the width of the fibers 302, 303 on the perimeter of the clear area 305. Since these are squares, the clear area is easily calculated by measuring the inside dimension, s, of one side of the square 301 and squaring that to get A_{c}. By also taking s and adding the width of the fiber to get s₁, squaring s₁ and subtracting A_{c} from s₁² the area covered by the fibers 302, 303, A_{f}, is obtained. A clear space ratio (CSR) may then be calculated as A_{f}/A_{c}. In select embodiments of the present invention: 0.25≦CSR≦4. For example, for s=1, width of fiber=0.2, A_{c}=1, s₁=1.2, s₁²=1.44 and A_{f}=1.44−1=0.21 and CSR=0.44/1=0.44, an “open-weave” scrim that falls within the above limits. These open-weave scrims are less expensive than a woven cloth or mesh and may provide nearly the same protection while achieving reductions in both cost and weight.

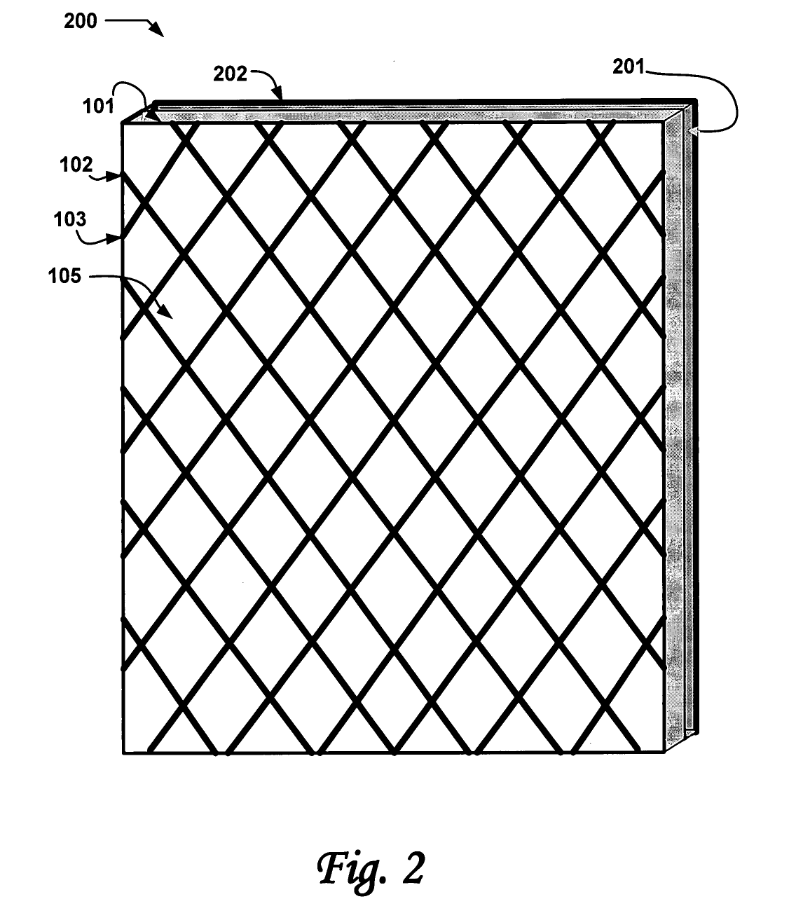

Refer to FIG. 2 which depicts an embodiment 200 that includes the reinforced membrane 100 of FIG. 1 and an adhesive layer 201 that may be applied in a variety of ways known to those skilled in the art. For example, in select embodiments of the present invention, the adhesive layer 201 may be sprayed, brushed or rolled on the membrane 101 itself at the location of application of the reinforced membrane 100 to the structural member (not shown separately). Alternatively, in select embodiments of the present invention the adhesive layer 201 may be applied directly to the structural member itself and the reinforced membrane 100 pressed onto the structural member. In select embodiments of the present invention an adhesive layer 201 may be applied to each of the reinforced membrane 100 and the structural member and the reinforce membrane 100 pressed onto the structural member. As an option, FIG. 2 also depicts the incorporation of a protective layer (peelable layer) 202 for use with an embodiment of the present invention having a “peel and stick” configuration, that is the adhesive layer is applied to the reinforced membrane 100 at the factory and the adhesive layer is protected by a separate non-stick covering (peelable layer) 202 suitable for peeling off the reinforced membrane 100 just prior to application of the reinforced membrane 100 at the job site.

In select embodiments of the present invention, the adhesive for bonding the reinforced elastomeric material to a structure is preferably a “pressure sensitive” adhesive, i.e., the elastomeric material is bonded to the structure by applying pressure to the elastomeric material once it is “fitted” to the structure. Pressure sensitive adhesives used in select embodiments of the present invention may be selected from those comprising at least in part any of: rubber, acrylic, epoxy, urethane, polyurea and combinations of the above. The minimum bond strength of adhesives used in select embodiments of the present invention referencing Pressure Sensitive Tape Council (PSTC) Standards 3 and 6 or ASTM D-3330 is at least 40 oz./in. to maintain a cohesive bond to the structural element. For select embodiments of the present invention, the adhesive thickness is from about 2 mil to about 50 mil.

### EXAMPLE

An example specification for a reinforced elastomeric configuration useful in select embodiments of the present invention may be:

a thermoplastic membrane
thickness of 20 mil
strength of 167 pli

a flat fiber bundle comprising aramid fibers
angle of placement of fiber bundle with respect to longitudinal axis, 45°
strength of 200 pli
thickness of 0.006 in. (0.15 mm)
CSR=0.84

an acrylic adhesive
applied thickness of about 11.2 mil
bond strength of 50 oz./in. per PSTC-3 and ASTM D-3330

### Tests

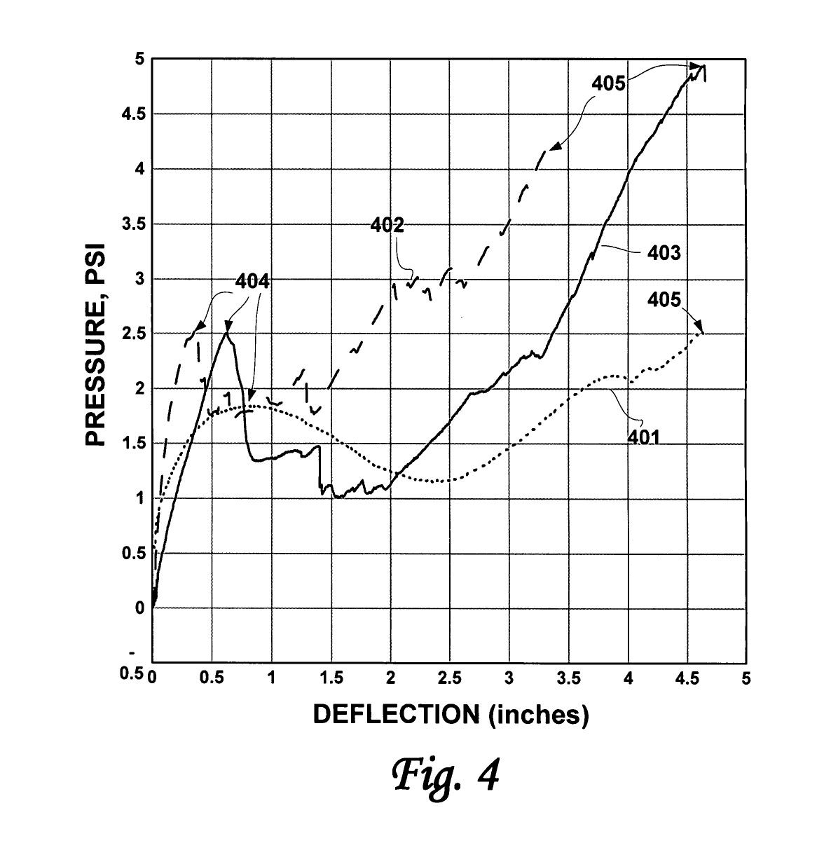

Tests were conducted for selected embodiments of the invention. Refer to FIG. 4. In a first series of hydrostatic tests, three concrete-masonry unit (CMU) walls (not shown separately) were fabricated for testing. A first of these CMU walls, the control, had an elastomeric material affixed to one side. A second of these walls had the same elastomeric material affixed to one side but the elastomeric material incorporated a reinforcing scrim of aramid fibers that was provided at a 0/90° orientation to the longitudinal axis of this second wall, i.e., the warp was provided at 0° and the weft at 90° to the longitudinal axis. The third of these walls had the same elastomeric material affixed to one side as the first two walls but the elastomeric material incorporated a reinforcing scrim of aramid fibers that was provided at a 45/−45° orientation to the longitudinal axis of this second wall, i.e., the warp was provided at 45° and the weft at −45° to the longitudinal axis. All three walls were stressed to fracture as shown at 404. Further, all three walls were stressed to the rupture of their respective elastomeric configurations as shown at 405.

Curve 401 shows the performance of the control wall. As may be expected, the control wall failed (at point 404) at a lower pressure (1.84 psi) and greater deflection (0.82 in.) than either of the other two. Also, the elastomeric material stretched to failure at a much lower pressure (2.51 psi) and higher deflection (4.63 in.) than either of the reinforced configurations. Referring to curve 402, it is evident that the elastomeric material with the 0/90° orientation of the aramid fibers is stiffer throughout the test and slightly stronger initially than that of the 45/−45° orientation. The 0/90° configuration of the aramid fibers sustains a pressure of 2.54 psi with a deflection of only 0.38 in. at the point of failure of the wall as shown at 404 on curve 402. The elastomeric material itself fails at 4.22 psi at a deflection of 3.36 in., again indicating its “stiffness” as compared to either of the other two configurations. Referring to curve 403, it is evident that the reinforced elastomeric material “gives” more both at the initial failure point 404 of the wall (2.5 psi at 0.63 in. deflection) and at failure of the elastomeric material configuration itself (4.94 psi at 4.65 in. deflection). This additional yielding enables the 45/−45° configuration to prolong the period over which any external impact occurs, resulting in improved resistance to a: wall fracture that results in flying debris. Another benefit to the 45/−45° configuration is the additional strength exhibited when, the elastomneric material is stressed along the longitudinal axis of the wall to failure along the horizontal axis of the wall (4.94 psi compared to 4.22 psi for the 0/90° configuration). The physics can be explained by comparing a 0/90° configuration to a 45/−45° configuration as a CMU wall is stressed along a horizontal mortar joint, for example. Both of the fibers in the 45/−45° orientation tend towards realignment in the stiffest orientation, i.e., 90° to the mortar joint. In the 0/90° configuration only the 90° fibers (half of the total) contribute to resisting the load on the wall since the 0° fibers provide no additional strength or ductility with respect to the stress imposed at the horizontal mortar joint.

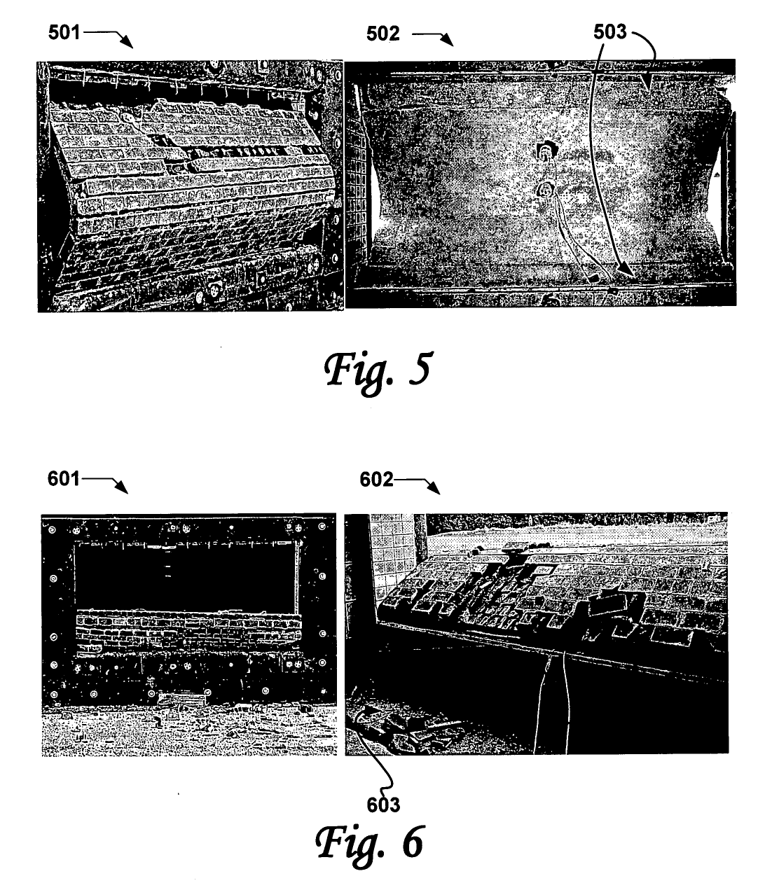

In addition to hydrostatic tests, “blast” tests were performed for the three configurations described above. All of the sub-scale CMU walls tested in this series had an elastomeric material affixed both to the walls and to the adjacent support structure at both the top and bottom of the sub-scale CMU walls. For the reported results, a fractional “normalized” (relative) value represents both the relative pressure, P, and the relative impulse, I, observed at the test wall for each of these tests, with a relative value of 1.0 being the maximum pressure, P, or impulse, I, observed for all cases. Refer to FIG. 5, a pictorial representation of the results of a first test of a sub-scale CMU wall in which P=0.48 and I=0.73. The CMU wall had un-reinforced elastomeric material affixed to the inside (the side away from the blast) of the test CMU wall and further affixed 503 at both the top and bottom of the test CMU wall to the test support structure. As can be seen from the outside view 501, the test CMU wall buckled but, as can be seen from the inside view 502, did not result in penetration of the elastomeric material, thus yielding no flying debris on the inside.

Refer to FIG. 6, showing the results of a second blast test with P=0.67 and I=0.84, a somewhat stronger blast than in the first test with pressure about 40% greater and impulse near 15% greater. The elastomeric material was applied in the same manner as for the first test but was reinforced with 0/90° aramid fibers. Although the elastomeric material was reinforced, this second CMU wall failed right at a horizontal mortar line as can be seen from both outside 601 and inside 602 views, allowing debris 603 to be deposited inside the wall. A contributing factor was the orientation of the 0/90° scrim. As noted above, only half of the aramid fibers (the warp fibers at 90° to the horizontal mortar line) were available to resist pressure and impulse forces somewhat higher than in the first blast test above.

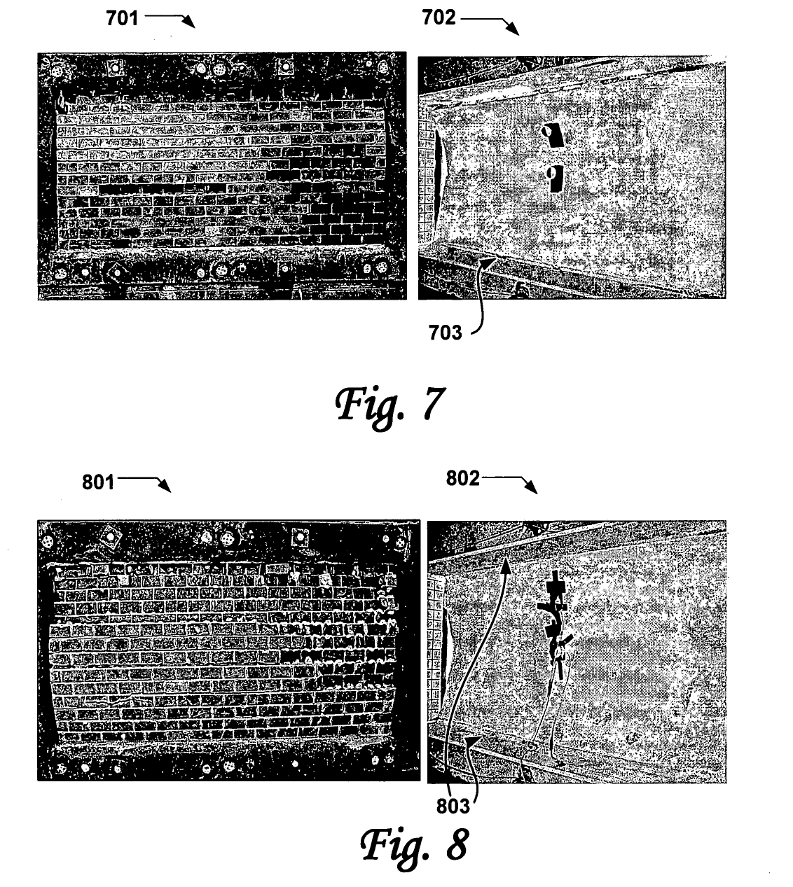

Refer to FIG. 7, showing the results of a third blast test with P=0.67 and I=0.84, a blast of the same size as in the second blast test above. The elastomeric material was applied in the same manner as for the second test but was reinforced with 45/−45° aramid fibers having the same tensile strength as in the second test. Although the reinforcement in the elastomeric material was of the same tensile strength as for the second test, this third CMU wall bulged only slightly and lost only a few parts of the CMU wall as seen from the exterior view 701 and bulged right at a horizontal mortar line (best seen in the inside view 702) but maintained the integrity of the interior of the space behind the CMU wall. The elastomeric material appeared to pull away at the top but maintained its integrity at the bottom 703 of the sub-scale CMU wall. A contributing factor was the orientation of the 45/−45° scrim. As noted above, all of the aramid fibers (the warp fibers at −45° to the horizontal mortar line and the weft fibers at 45° to the horizontal mortar line) were available to resist the same pressure and impulse forces that destroyed the wall in the second test.

Refer to FIG. 8, a pictorial representation of a fourth test in which both P and I were maximized at the normalized value 1.0. The elastomeric material was applied in the same manner as for the second test but was reinforced with 45/−45° aramid fibers having twice the tensile strength as in the second and third test. Although the pressure of the blast for this test was almost 50% greater and the impulse almost 20% greater, this fourth CMU wall bulged only slightly and lost only a few more parts of the CMU wall as seen from the exterior view 801 and bulged right at a horizontal mortar line (best seen in the inside view 802) but maintained the integrity of the interior of the space behind the CMU wall. Unlike the third test, the elastomeric material did not pull away at the top 803 but maintained its integrity at both the top and bottom 803 of the sub-scale CMU wall. A contributing factor was the combination of a stronger aramid fiber and the orientation of the 45/−45° scrim. As noted above, all of the aramid fibers (the warp fibers at −45° to the horizontal mortar line and the weft fibers at 45° to the horizontal mortar line) were available-to resist:a much larger force than that which destroyed the wall in the second test;

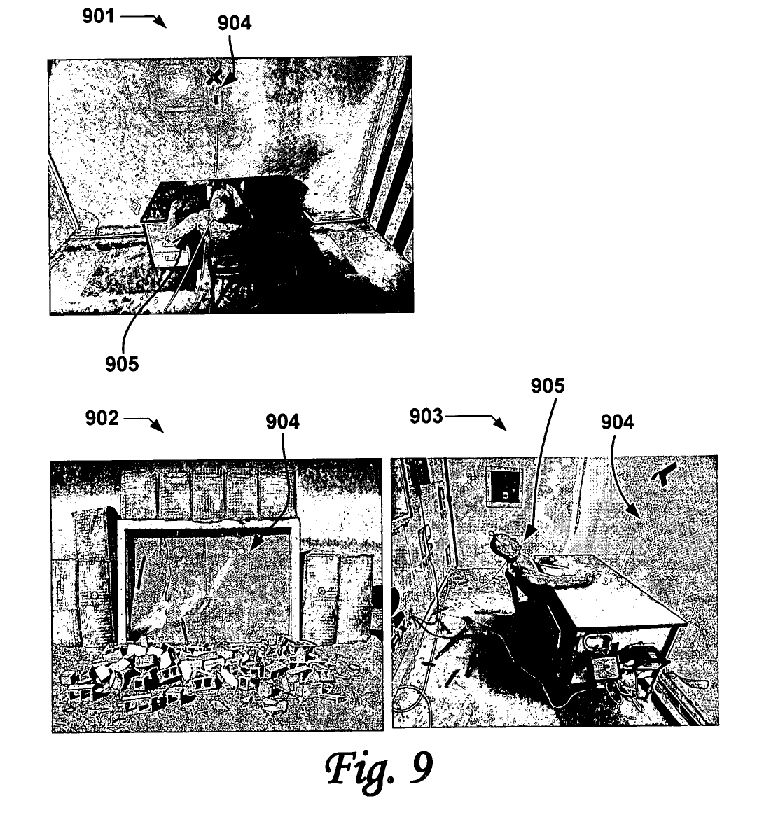

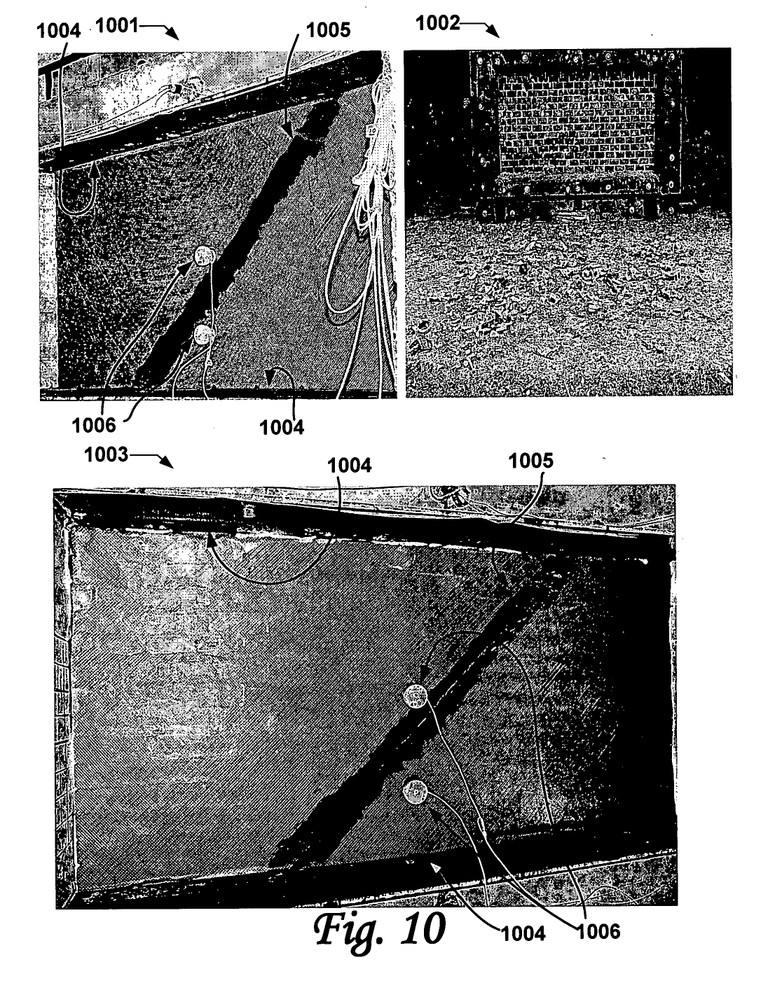

Refer to FIG. 9, a pictorial representation of a full-scale test, both before 901 and after 902, 903 in which the pressure and impulse values were comparable to nearly the maximum dynamic loading applied to the sub-scale CMU wall experiments. Note the presence of an instrumented dummy 905 behind a desk and no change in position between the before 901 and after 903 pictorial representations. The elastomeric material was applied with a pressure sensitive adhesive and was reinforced with a material composed of 45/−45° aramid fibers. The CMU wall was completely destroyed except for the elastomeric configuration which was not penetrated by any flying debris as seen from the exterior view 902 and inside view 903. The reinforced “peel and stick” elastomeric configuration maintained the integrity of the interior of the space behind the CMU wall as seen in the post-blast inside view 903 in which the seams 904 of the elastomeric material applied with pressure-sensitive adhesive are not separated. Unlike the fourth test, the elastomeric material did not adhere to the CMU wall but maintained its integrity when the entire wall collapsed on the exterior side of the wall. Again, a contributing factor was the strength and orientation of the 45/−45° scrim. As noted above, all of the aramid fibers (the warp fibers at −45° to the horizontal mortar line and the weft fibers at 45° to the horizontal mortar line) were available to resist a much larger force than that which destroyed the sub-scale wall in the second test.

Refer to FIG. 10, a pictorial representation of a sub-scale test, both before 1001 and after 1002, 1003 in which the reinforced elastomeric configuration has aramid fibers 102, 103 in a 0/90° orientation with respect to the reinforced elastomeric configuration itself but the reinforced elastomeric configuration is applied on a bias of 45/−45° to the CMU wall. To achieve the 45/−45° orientation of the scrim with respect to the CMU wall, the reinforced elastomeric configuration was cut into strips for diagonal application to the CMU wall, thus the seam 1005 crosses the wall at angle of 45 degrees. Instrumentation 106 was placed on each side of the diagonal 105 and the strips were extended to be anchored at the top and bottom of the test structure as shown at 1004. The pressure and impulse values were comparable to nearly the maximum dynamic loading applied to the above sub-scale CMU wall experiments. Note the extent of damage to the outside of the CMU wall at 1002. Although an elastomeric configuration with a 0/90° scrim may be used in an embodiment of the present invention the amount of additional labor and the waste of material in applying to rectangular walls militates against this approach. Despite the damage to the exterior CMU wall (shown in 1002) the reinforced elastomeric configuration was not penetrated by any flying debris as seen from the post-test inside view 1003 in which the seams 1005 of the elastomeric material reinforced with adhesive are not separated. Again, a contributing factor was the strength and orientation of the reinforced elastomeric configuration applied on a bias of 45° to the CMU test wall. As noted above, all of the aramid fibers (the warp fibers at −45° to the horizontal mortar line and the weft fibers at 45° to the horizontal mortar line) were available to resist a dynamic force that did considerable damage to the sub-scale CMU wall.

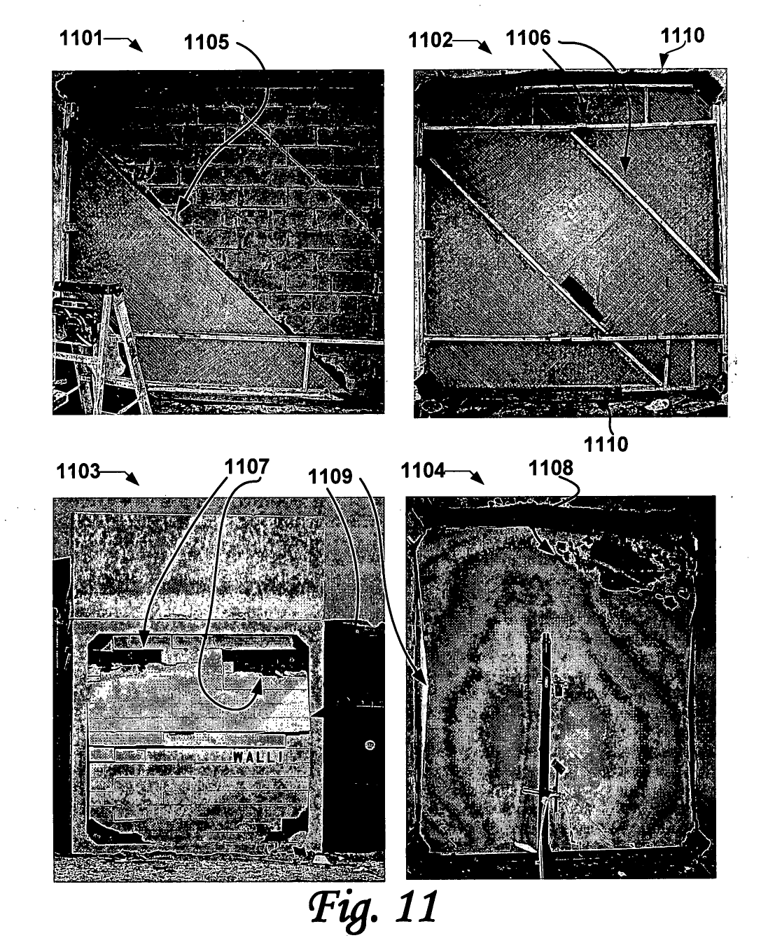

Refer to FIG. 11, a pictorial representation of a full-scale test, both before 1101, 1102 and after 1103, 1104. Like the test immediately above (shown in FIG. 10), the reinforced elastomeric configuration has aramid fibers 102, 103 in a 0/90° orientation with respect to the reinforced elastomeric configuration itself but the reinforced elastomeric configuration is applied on a bias of 45/−45° to the CMU wall. To achieve the 45/−45° orientation of the scrim with respect to the CMU wall, the reinforced elastomeric configuration was cut into strips for diagonal application to the CMU wall, thus the seam 1105 crosses the wall at angle of 45 degrees. The pressure and impulse values were 36% and 17% lower respectively than the maximum dynamic loading applied to the above full-scale CMU wall experiment (FIG. 9). The elastomeric material, reinforced with a material composed of 0/90° aramid fibers, was applied with an adhesive that required the use of a support frame 1106 to maintain the position of the “bias-cut” reinforced elastomeric configuration on the full-size CMU wall until final cure of the adhesive. The CMU wall was buckled (as seen at 1109) but the reinforced elastomeric configuration was not penetrated by any flying debris as seen from the exterior view 1103 and inside view 1104 despite severe damage at 1107 resulting in some peeling of the paint on the reinforced elastomeric configuration at 1108. As with other test configurations, the reinforced elastomeric configuration was affixed to both the top and bottom of the test structure as shown at 1110 but not to the sides, thus the sides did buckle somewhat as shown at 1109. Again, a contributing factor was the strength and orientation of the bias-cut (45°) reinforced elastomeric configuration. As noted above, all of the aramid fibers (the warp fibers at −45° to the horizontal mortar line and the weft fibers at 45° to the horizontal mortar line) were available to resist a dynamic force than did considerable damage to the outside of the full-scale CMU wall.

The ability to choose among many polymer or copolymer materials for an appropriate skin material. 102, 103 makes embodiments of the present invention suitable for use in a variety of military, commercial, industrial and consumer applications.

The abstract of the disclosure is provided to comply with the rules requiring an abstract that will allow a searcher to quickly ascertain the subject matter of the technical disclosure of any patent issued from this disclosure. 37 CFR § 1.72(b). Any advantages and benefits described may not apply to all embodiments of the invention.

While the invention has been described in terms of some of its embodiments, those skilled in the art will recognize that the invention can be practiced with modifications within the spirit and scope of the appended claims. For example, although the system is described in specific examples for improving the resistance of structural members to impact, blast and fragmentation effects, it may apply to any number of applications including containment facilities in industrial areas or for containment within shipping containers used for transportation of hazardous materials.

In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Thus, it is intended that all matter contained in the foregoing description or shown in the accompanying drawings shall be interpreted as illustrative rather than limiting, and the invention should be defined only in accordance with the following claims and their equivalents.

We claim:

1. A prophylactic system for reducing or eliminating damage to the inside of a structure having sides which upon impact by an external force would otherwise generate flying debris inside said structure, comprising:
an elastomeric configuration of a toughness tailored to a user's requirements having a length, a width, and a thickness, said thickness much less than either of said length or said width, said elastomeric configuration incorporating at least some reinforcement,
wherein said reinforcement comprises bundles of fibers, said fiber bundles aligned in a scrim, said scrim comprised of warp fiber bundles and weft fiber bundles, said fiber bundles non-parallel to each of the axes defining said length and said width of said elastomeric configuration, and
wherein said fiber bundles are aligned to create spacing between each said fiber bundle and a next said fiber bundle parallel thereto; and
adhesive,
wherein said adhesive is applied to affix said reinforced elastomeric configuration to at least a portion of the inside of at least one of said sides of said structure.

2. The prophylactic system of claim 1 in which said reinforced elastomeric configuration is selected from a group consisting of: polymers, copolymers, and combinations thereof, in which said reinforcement is embedded.

3. The prophylactic system of claim 1 in which at least one of said materials comprising said reinforced elastomeric configuration is selected from the group consisting of: elastomeric polymers, copolymers, polyurethane, polyurea, polyethylene, polypropylene, polyolefin, silicone, polychloroprene, polyisoprene, isobutylene isoprene, polyvinylalcohol (PVA), polyvinylbutryl (PBA), polymer ionomer resins, modified polyolefin, halogenated polyolefin, polyester, urethane, rubber, hydrocarbons, ethylene-propylene terpolymer, chlorosulfonated polyethylene, styrene butadiene, polysulfide, acrylonitrile butadiene, fluoroelastomer, epichloronydrin, and combinations thereof.

4. The prophylactic system of claim 1 in which said reinforced elastomeric configuration exhibits a strength of between about 100 to about 800 pounds per linear inch (pli).

5. The prophylactic system of claim 1 in which said reinforced elastomeric configuration is provided in a thickness between about 10 mil to about 0.5 in. (12.7 mm).

6. The prophylactic system of claim 1 in which said reinforced elastomeric configuration is capable of elongation from about 100% to about 500%.

7. The prophylactic system of claim 1 in which at least one material for at least one type of said fibers is selected from the group consisting of: polyester, aramid, para-aramid, aromatic polyamide, poly(p-phenylene-2,6-benzobiosoxazole), fiberglass, carbon fiber, polypropylene, nylon, aliphatic polymer, ultra-high molecular weight polyethylene (UHMWPE), high modulus polyethylene (HMPE), geo-grid material, bi-axial geo-grid material, geo-fabric material, bi-axial geo-fabric material, metallic grids, metallic meshes, metallic membranes, and combinations thereof.

8. The prophylactic system of claim 7 in which said fibers are incorporated in said fiber bundles aligned so that said spacing is defined by a pre-specified clear space ratio (CSR) defined as the area of said scrim covered by the fiber bundles divided by the area of said scrim that is not covered by the fiber bundles.

9. The prophylactic system of claim 8 in which said CSR is specified to be between about 0.25 and about 4.0.

10. The prophylactic system of claim 1 in which the greatest dimension perpendicular to the longitudinal axis of each of the fiber bundles is at least about 0.005 in. (0.13 mm).

11. The prophylactic system of claim 1 in which breaking strength of individual fibers in said fiber bundles is at least about 5 grams per denier (gpd).

12. The prophylactic system of claim 1 in which the breaking strength of said fibers in said fiber bundles is between about 10 and about 30 gpd.

13. The prophylactic system of claim 1 in which the configuration of said fiber bundles is selected from the group consisting of: woven, braided, stitched, mesh fabric, and combinations thereof.

14. The prophylactic system of claim 1 in which said warp fiber bundles of said scrim are fixed at between about 30 and about 60 degrees with respect to the longitudinal axis of said reinforced elastomeric configuration and said weft fiber bundles of said scrim are fixed about perpendicular to said warp fiber bundles.

15. The prophylactic system of claim 1 in which said warp fiber bundles of said scrim are fixed at between about 30 and about 60 degrees with respect to the longitudinal axis of said reinforced elastomeric configuration and said weft fiber bundles of said scrim are fixed non-perpendicular to said warp fiber bundles.

16. The prophylactic system of claim 1 in which said warp fiber bundles of said scrim are fixed at about 45 degrees with respect to the longitudinal axis of said reinforced elastomeric configuration and said weft fiber bundles of said scrim are fixed about perpendicular to said warp fiber bundles.

17. The prophylactic system of claim 1 in which said warp fiber bundles of said scrim are fixed at about 45 degrees with respect to the longitudinal axis of said reinforced elastomeric configuration and said wett fiber bundles of said scrim are fixed non-perpendicular to said warp fiber bundles.

18. The prophylactic system of claim 1 in which said reinforced elastomeric configuration is extended to be affixed to at least one portion of said structure that abuts at least one said side.

19. The prophylactic system of claim 18 in which said at least one portion includes at least the ceiling and the floor abutting said at least one side.

20. The prophylactic system of claim 1 in which said adhesive is applied to said at least one side prior to affixing said reinforced elastomeric configuration to said at least one side.

21. The prophylactic system of claim 1 in which said adhesive is applied to both said reinforced elastomeric configuration and said at least one side prior to affixing said reinforced elastomeric configuration to said at least one side.

22. The prophylactic system of claim 1 in which said adhesive is applied to said reinforced elastomeric configuration prior to affixing said reinforced elastomeric configuration to said at least one side.

23. The prophylactic system of claim 1 in which said adhesive is applied to said reinforced elastomeric configuration at the place of manufacture of said reinforced elastomeric configuration, said applied adhesive protected with a peelable sheet that is removed just prior to affixing said reinforced elastomeric configuration to said at least one side.

24. The prophylactic system of claim 1 in which said adhesive is of a type that may be used with no need for safety gear specific to use of said adhesive.

25. The prophylactic system of claim 1 in which components of said adhesive are selected from the group consisting of: rubber, acrylic, epoxy, urethane, polyurea and combinations of the above.

26. The prophylactic system of claim 1 in which said adhesive has a minimum bond strength of at least 40 oz./in.

27. The prophylactic system of claim 1 in which said adhesive is applied at a thickness from about 2 mil to about 50 mil.

28. A structure having at least exterior walls and incorporating a prophylactic system, for significantly reducing or eliminating damage to the inside of said structure should said exterior walls be impacted by an external force that otherwise would generate flying debris inside said structure, said prophylactic system comprising:
an elastomeric configuration of a toughness tailored to a user's requirements having a length, a width, and a thickness, said thickness much less than either of said length or said width, said elastomeric configuration incorporating at least some reinforcement,
wherein said reinforcement comprises bundles of fibers, said fiber bundles aligned in a scrim, said fiber bundles non-parallel to the axes defining said length and said width of said reinforced elastomeric configuration, and
wherein said fiber bundles are aligned to create spacing between each said fiber bundle and a next said fiber bundle parallel thereto; and
adhesive,
wherein said adhesive is applied to affix said reinforced elastomeric configuration to at least a portion of the inside of at least one of said exterior walls of said structure.

29. A prophylactic system for significantly reducing or eliminating damage to items outside a structure should the interior sides of exterior walls be impacted by an internal force that otherwise would generate flying debris outside said structure, comprising:
an elastomeric configuration of a toughness tailored to a user's requirements having a length, a width, and a thickness, said thickness much less than either of said length or said width, said elastomeric configuration incorporating at least some reinforcement,
wherein said reinforcement comprises bundles of fibers, said fiber bundles aligned in a scrim, said fiber bundles non-parallel to the axes defining said length and said width of said reinforced elastomeric configuration, and
wherein said fiber bundles are aligned to create spacing between each said fiber bundle and an adjacent parallel said bundle; and
adhesive,
wherein said adhesive is applied to affix said reinforced elastomeric configuration to at least a portion of the outside of at least one of said exterior walls of said structure.

30. A prophylactic system for reducing or eliminating damage to the inside of a structure having sides which upon impact by an external force would otherwise generate flying debris inside said structure, comprising:
an elastomeric configuration of a toughness tailored to a user's requirements having a length, a width, and a thickness, said thickness much less than either of said length or said width, said elastomeric configuration incorporating at least some reinforcement,
wherein said reinforcement comprises bundles of fibers, said fiber bundles aligned in a scrim, said scrim comprised of warp fiber bundles and weft fiber bundles, said fiber bundles approximately parallel to each of the axes defining said length and said width of said elastomeric configuration, and
wherein said fiber bundles are aligned to create spacing between each said fiber bundle and a next said fiber bundle parallel thereto, and
wherein said prophylactic system is aligned on a bias with respect to either of said axes defining said length and said width; and
adhesive,
wherein said adhesive is applied to affix said reinforced elastomeric configuration to at least a portion of the inside of at least one of said sides of said structure.

31. A prophylactic system for significantly reducing or eliminating damage to items outside a structure should the interior sides of exterior walls be impacted by an internal force that otherwise would generate flying debris outside said structure, comprising:
an elastomeric configuration of a toughness tailored to a user's requirements having a length, a width, and a thickness, said thickness much less than either of said length or said width, said elastomeric configuration incorporating at least some reinforcement,
wherein said reinforcement comprises bundles of fibers, said fiber bundles aligned in a scrim, said fiber bundles non-parallel to the axes defining said length and said width of said reinforced elastomeric configuration, and
wherein said fiber bundles are aligned to create spacing between each said fiber bundle and an adjacent parallel said bundle, and
wherein said prophylactic system is aligned on a bias with respect to either of said axes defining said length and said width; and
adhesive,
wherein said adhesive is applied to affix said reinforced elastomeric configuration to at least a portion of the outside of at least one of said exterior walls of said structure.
